(19) United States
(12) Patent Application Publication
(10) Pub. No.: US 2008/0042975 A1
(43) Pub. Date: Feb. 21, 2008

(54) System and method for controlling the movement of an object using a user-controlled pointing device that measures magnetic fields

(76) Inventor: Gary R. Trott, San Mateo, CA (US)

Correspondence Address: Kathy Manke;Avago Technologies Limited, 4380 Ziegler Road, Fort Collins, CO, 80525, US

(21) Appl. No.: 11/506,255

(22) Filed: Aug. 18, 2006

(51) Int. Cl. G09G 5/08

(52) U.S. Cl. 345/157

(57) ABSTRACT

A user observes an object in a visual scene and moves a user-controlled pointing device that measures magnetic fields to control or move the object. One or more magnetic sensors are included within the user-controlled pointing device and each magnetic sensor measures a magnetic field component associated with a respective orthogonal direction. A processing circuit receives an output signal from each magnetic sensor that represents the respective magnetic field component measured by that sensor. The processing circuit then tracks the movement of the pointing device using the output signals received from each magnetic sensor. Positional information for the object is determined based on the tracked movement of the user-controlled pointing device. The positional information is transmitted to a controller associated with the object using a communications link established between the pointing device and the controller.

### BACKGROUND

Navigational devices have been used with computers and other types of electronic devices and gaming systems for many years. A computer mouse is one example of a navigation device. With a mechanical computer mouse, a ball rolls over a flat surface as the mouse is moved. Interior to the mouse are wheels that contact the ball and covert its rotation into electrical signals representing orthogonal components of motion.

Another type of computer mouse is an optical mouse. FIG. 1 is a diagrammatic illustration of a portion of an optical mouse according to the prior art. Mouse 100 includes light source 102 and imager 104. Light source 102 is typically implemented as a light-emitting diode, which emits light 106 towards surface 108. Imager 104 captures images from surface 108 and transmits the images to processing circuit 110. Processing circuit 110 typically correlates the images to track the motion of objects within the images. The speed and distance mouse 100 has moved across surface 108 is determined from the results of the correlation process.

Contamination in the optical path between surface 108 and imager 104 can reduce the ability of processing circuit 110 to determine motion. Contamination such as dust, lint, and condensation appear as background noise that remains relatively constant from image to image and reduces the efficiency of the correlation engine. Moreover, when surface 108 is formed from glass, most of the light emitted by light source 104 transmits through surface 108, thereby making it difficult for imager 104 to capture images that can be used to track the motion of objects within the images.

### SUMMARY

In accordance with the invention, a system and method for controlling the movement of an object using a user-controlled pointing device that measures magnetic fields are provided. One or more magnetic sensors are mounted within the user-controlled pointing device. A user moves the pointing device to move or control an object the user is observing in a visual scene. For example, the user moves the user-controlled pointing device to control the movement of a cursor on a display device in an embodiment in accordance with the invention. In another embodiment in accordance with the invention, the user moves the user-controlled pointing device to control the movement of a remote-controlled toy or industrial robot.

Each magnetic sensor in the user-controlled pointing device measures a magnetic field component associated with a respective orthogonal direction. A processing circuit receives an output signal from each sensor that represents the respective magnetic field component measured by that magnetic sensor. The processing circuit responsively tracks the movement of the user-controlled pointing device and calculates corresponding positional information for the object in an embodiment in accordance with the invention. The positional information is transmitted to a controller associated with the object using a communications link established between the pointing device and the object controller.

A user calibrates the user-controlled pointing device for a new location when the user first uses the pointing device in that location in an embodiment in accordance with the invention. The user moves the pointing device over a field of motion for each orthogonal direction the pointing device is to be moved. As the pointing device moves in each orthogonal direction, the magnetic field component associated with that orthogonal direction is measured and the differences in the component are used to calculate the distance the pointing device moved. The distance the pointing device moved is then translated into a distance or movement associated with the object. This involves applying a scaling factor or gain to the magnetic field component in an embodiment in accordance with the invention.

### BRIEF DESCRIPTION OF THE DRAWINGS

FIG. 1 is a diagrammatic illustration of a portion of an optical mouse in accordance with the prior art;

FIG. 2 illustrates a flowchart of a method for controlling the movement of an object using a user-controlled pointing device that measures magnetic fields in an embodiment in accordance with the invention;

FIG. 3 depicts a flowchart of a method for calibrating a pointing device that can be executed at block 202 in FIG. 2;

FIG. 4 is a diagrammatic illustration of a portion of a first pointing device in an embodiment in accordance with the invention;

FIG. 5 is a diagrammatic illustration of a portion of a second pointing device in an embodiment in accordance with the invention;

FIG. 6 illustrates two mounting plates each with a magnetic sensor mounted thereon in an embodiment in accordance with the invention; and

FIG. 7 illustrates a mounting cube with three magnetic sensors mounted thereon in an embodiment in accordance with the invention.

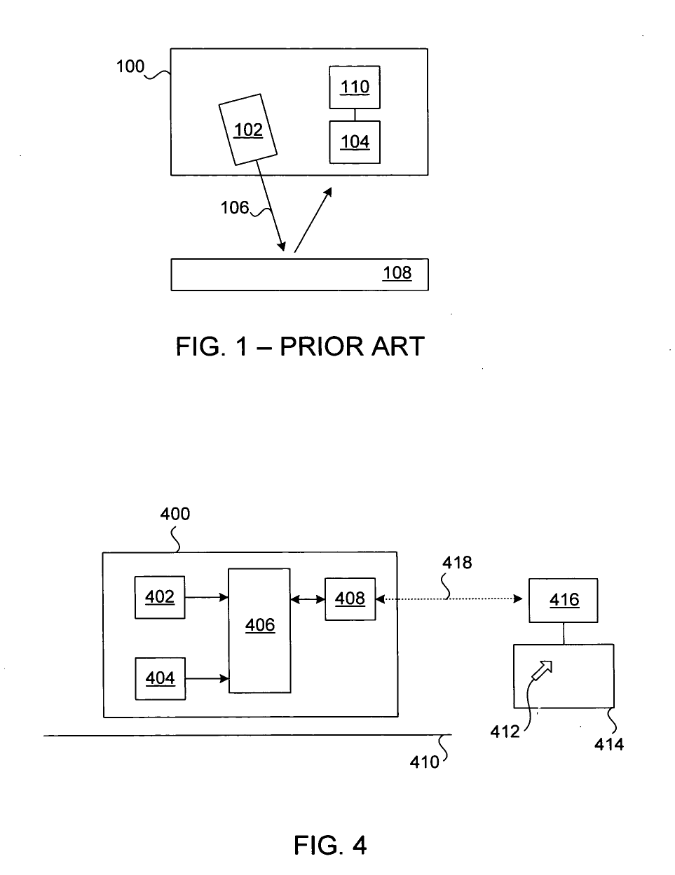

### DETAILED DESCRIPTION

The following description is presented to enable embodiments of the invention to be made and used, and is provided in the context of a patent application and its requirements. Various modifications to the disclosed embodiments will be readily apparent, and the generic principles herein may be applied to other embodiments. Thus, the invention is not intended to be limited to the embodiments shown but is to be accorded the widest scope consistent with the appended claims. Like reference numerals designate corresponding parts throughout the figures.

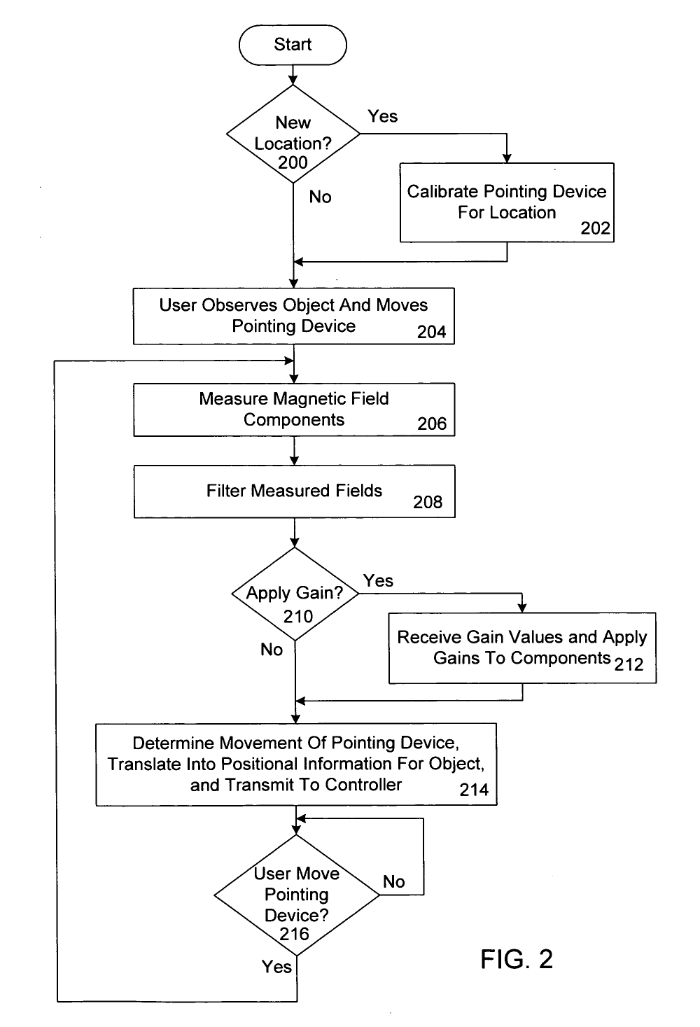

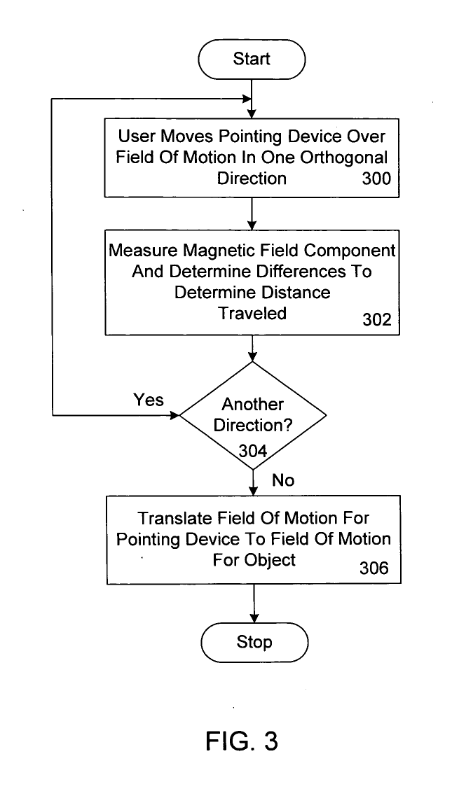

FIG. 2 illustrates a flowchart of a method for controlling the movement of an object using a user-controlled pointing device that measures magnetic fields in an embodiment in accordance with the invention. Initially, a user determines whether he or she will be using the pointing device in a new location (block 200), and if so, calibrates the pointing device for that location (block 202). Since the pointing device uses local pervasive magnetic fields to determine positional information, the environment surrounding a magnetic sensor can adversely affect the ability of the magnetic sensor to measure magnetic fields. For example, the metal girders in a building can disturb or shield the magnetic fields and affect the performance of a magnetic sensor. Other metal objects and objects that contain metal, such as, for example, metal cabinets and machinery, can also affect the performance of a magnetic sensor. The calibration process is described in more detail in conjunction with FIG. 3.

If the user is not using the pointing device in a new location, the method passes to block 204 where the user observes the object in a visual scene and moves the pointing device to move or control the object. For example, the visual scene is an image displayed on a display and the user moves the pointing device to control the movement of a cursor included in the image in an embodiment in accordance with the invention. Examples of display devices include, but are not limited to, a computer, digital video recorder, television, music player, and personal digital assistant.

In another embodiment in accordance with the invention, the visual scene includes a view of the object and the user moves the user-controlled pointing device to control the movement of a remote-controlled object. Examples of such objects include, but are not limited to, a remote-controlled electronic device, such as a remote controlled toy, a gaming system, or an industrial robot used in a manufacturing or testing facility.

Next, at block 206, each magnetic sensor in the pointing device measures the magnetic field component associated with a respective orthogonal direction. The measured magnetic field components are then filtered to isolate the DC magnetic field components, as shown in block 208. The DC magnetic field components are used for navigation in one embodiment in accordance with the invention because the speed of the changes in the DC magnetic field components is comparable to the speed at which a user moves his or her hand or hands.

A determination is then made at block 210 as to whether a gain is to be applied to one or more DC magnetic field components. A gain or scaling factor translates the movement of the pointing device to a field of motion associated with the object in an embodiment in accordance with the invention. If a gain is to be applied, the method passes to block 212 where the gain values are received and applied to the one or more DC magnetic field components. Each gain value is individually adjustable and programmed by a user in an embodiment in accordance with the invention. In another embodiment in accordance with the invention, the gain values are set by a manufacturer and stored in memory.

Next, at block 214, the changes in the position of the pointing device are tracked and translated into corresponding changes in object positions, movements, or functions. The positional information associated with the object is then transmitted to a controller associated with the object. For example, the positional information is transmitted to a display controller when the user is controlling the movement of a cursor on a display device. A determination is then made at block 216 as to whether the user is continuing to move the pointing device. If so, the method returns to block 206 and repeats each time the user moves the user-controlled pointing device.

Referring now to FIG. 3, there is shown a flowchart of a method for calibrating a pointing device that can be executed at block 202 in FIG. 2. Initially, a user moves the pointing device over its field of motion in one orthogonal direction, as shown in block 300. For example, a user moves the pointing device in the horizontal or x-direction for a pointing device that is confined to movement over a flat surface (i.e., two orthogonal directions). In another embodiment in accordance with the invention, the user moves the pointing device in the z-direction for a pointing device that moves in free space (i.e., three orthogonal directions).

The magnetic field component associated with the orthogonal direction is measured while the pointing device is moving and the differences in the magnetic field component determined in order to calculate the distance the pointing device moved in the one orthogonal direction (block 302). A determination is then made at block 304 as to whether there is another orthogonal direction in the field of motion that needs to be calibrated. If so, the method returns to block 300 and repeats until all of the magnetic field components and distances have been determined.

The distances in the field of motion for the pointing device are then translated into distances in a field of motion for the object, as shown in block 306. This typically involves applying a scaling factor or gain to one or more magnetic field components so that the object moves with a desired speed and accuracy within its field of motion. Other embodiments in accordance with the invention can translate the distances in the field of motion for the pointing device into distances in a field of motion for the object using different techniques.

FIG. 4 is a diagrammatic illustration of a portion of a first pointing device in an embodiment in accordance with the invention. Pointing device 400 includes magnetic sensors 402, 404, processing circuit 406, and communications device 408. Pointing device is moved over surface 410 in the embodiment shown in FIG. 4. FIG. 4 is described in conjunction with a user-controlled pointing device that controls the movement of a cursor on a display device, but embodiments in accordance with the invention are not limited to this implementation.

Surface 410 is a flat surface that allows pointing device 400 to move in two orthogonal directions (e.g., x-direction and y-direction) in the embodiment shown in FIG. 4. Consequently, magnetic sensors 402, 404 are independent sensors positioned orthogonal to each other within pointing device 400. This allows one sensor to measure the horizontal component of the magnetic fields while the other sensor measures the vertical component of the magnetic fields.

As discussed earlier, the pointing device uses local pervasive magnetic fields to determine positional information. Thus, magnetic sensors 402, 404 are sufficiently sensitive to measure at least a portion of the terrestrial fields, depending on how and where pointing device 400 is used. Magnetic sensors 402,404 are implemented as one of several commercially available magnetic sensors in an embodiment in accordance with the invention. Examples of such sensors include, but are not limited to, a complementary-metal-oxide-semiconductor (CMOS) fluxgate magnetometer designed by AICHI Micro Intelligent Corporation, or a digital magnetic compass component designed by Honeywell International.

As pointing device 400 moves over surface 410, each magnetic sensor 402, 404 generates an output signal that represents the respective magnetic field component measured by that sensor. Processing circuit 406 receives the output signals and tracks the direction and speed associated with the movement of the pointing device by analyzing the output signals from sensors 402, 404. The changes in the magnetic field components between measurement points are used to determine both the distance and the speed traveled by the pointing device.

Once the movement of pointing device 400 is determined, processing circuit 406 translates the motion of pointing device 400 into corresponding positional information for cursor 412 displayed on display device 414. Communications device 408 transmits corresponding positional information to controller 416 associated with display device 414 using a communications device associated with display device 414 (not shown) and communications link 418. Cursor 412 is moved on display 414 in response to the positional information. Based on the actions taken by a user and the changes in the image displayed on display 414, the user can repeatedly re-position cursor 412 by moving pointing device 400.

Although processing circuit 406 is described as receiving output signals from magnetic sensors 402, 404 and determining both the movement of pointing device 400 and the corresponding positional information for cursor 412, other embodiments in accordance with the invention are not limited to this implementation. By way of example only, processing circuit 406 receives the output signals from magnetic sensors 402, 404 but controller 416 determines both the movement of pointing device 400 and the corresponding positional information for cursor 412 in another embodiment in accordance with the invention. In another example, processing circuit 406 receives the output signals from magnetic sensors 402, 404 and determines the movement of pointing device 400 and controller 416 determines the corresponding positional information for cursor 412 in another embodiment in accordance with the invention.

Display device 414 is implemented separately from pointing device 400 in an embodiment in accordance with the invention. In another embodiment in accordance with the invention, display device 414 and pointing device 400 are assembled within the same host device.

Communications link 416 is implemented as a wired communications link or a wireless communications link. Output device 408 is implemented as any known output device that can transmit and receive data over a wired or wireless connection. By way of example, only, output device 408 is implemented as a Bluetooth-enabled wireless component in an embodiment in accordance with the invention.

And finally, pointing device 400 can be implemented with a different number of magnetic sensors in other embodiments in accordance with the invention. For example, surface 410 can be designed to constrain the movement of pointing device 400 to only one direction (e.g. side-to-side or up/down). In this situation, pointing device is constructed with only one magnetic sensor.

In another embodiment in accordance with the invention, surface 410 is flat but a user can rotate pointing device over surface 410. Pointing device 400 therefore includes three magnetic sensors to measure the local gradient of the volume of the magnetic field in the plane of surface 410. When the x and y magnetic field components of the gradient in the plane of surface 410 have been extracted, then translation of pointing device 400 on surface 410 can be mapped to the horizontal and vertical cursor motion on the display screen.

As discussed earlier, embodiments in accordance with the invention are not limited to using a pointing device that measures magnetic fields to control the movement of a cursor on a display screen. A pointing device that measures magnetic fields can be used to control the movement or function of any number of objects that can be controlled remotely. Examples of such objects include, but are not limited to, vehicles, testing devices, manufacturing equipment, toys, industrial robots, and consumer products such as music players, digital video recorders, and appliances. A user-controlled pointing device can be used to move an object or select a function associated with an object in various embodiments in accordance with the invention.

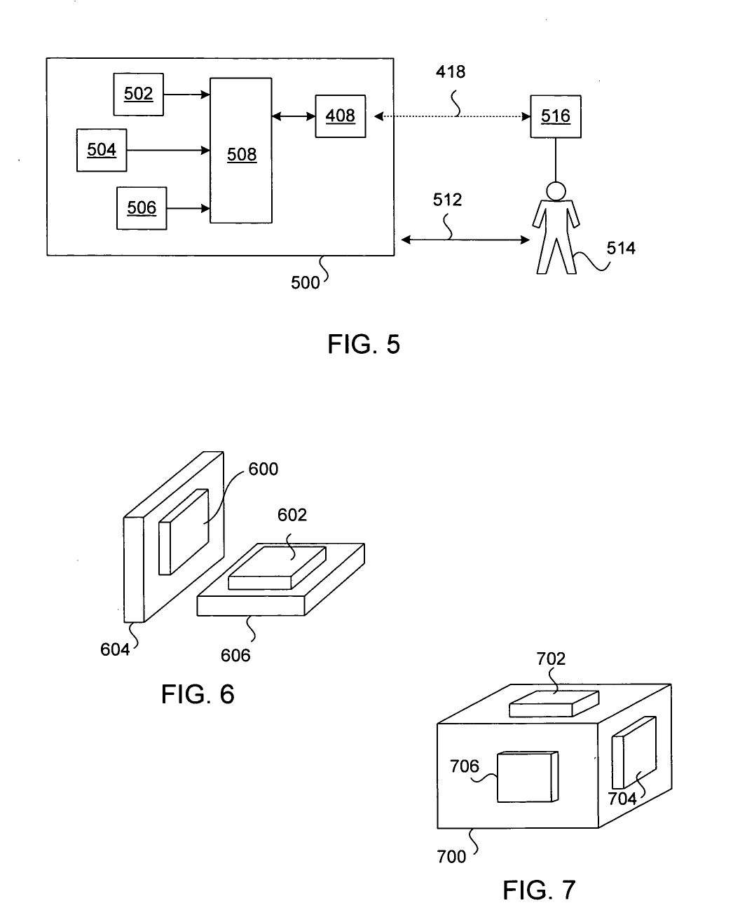

Referring now to FIG. 5, there is shown a diagrammatic illustration of a portion of a second pointing device in an embodiment in accordance with the invention. FIG. 5 is described in conjunction with a user-controlled pointing device that controls the movement of a robot, but embodiments in accordance with the invention are not limited to this implementation.

Pointing device 500 includes magnetic sensors 502, 504, 506, processing circuit 508, and communications device 408. Pointing device 500 is moved in free space or over a three dimensional surface in the embodiment shown in FIG. 5. Pointing device 500 is located a distance 512 from robot 514. A user observes robot 514 in a visual scene, such as a manufacturing or testing environment, and moves pointing device 500 to correspondingly control or move robot 514.

Magnetic sensors 502, 504, 506 are positioned within pointing device 500 such that sensors 502, 504, 506 are orthogonal to each other. With three dimensional movements, sensor 502 measures the magnetic field component in the x-direction, sensor 504 measures the magnetic field component in the y-direction, and sensor 506 measures the magnetic field component in the z-direction. Magnetic sensors 502, 504, 506 are implemented as one of several commercially available magnetic sensors, such as, for example, a digital magnetic compass component designed by Honeywell International.

As pointing device 500 moves, each magnetic sensor 502, 404, 506 generates one or more output signals that represent the respective magnetic field component measured by that sensor. Processing circuit 508 receives the output signals and applies a gain to one, two, or all three signals, if necessary. The direction, speed, and angular rotation associated with the moving of pointing device 500 are then determined by analyzing the output signals from sensors 502, 504, 506. The changes in the magnetic field components between measurement points are used to determine the distance, speed, and angular rotation traveled by pointing device 500. Corresponding positional information for robot 514 is then transmitted to controller 516 associated with robot 514 using communications link 418.

Although processing circuit 508 is described as receiving output signals from magnetic sensors 502, 504, 506 and determining both the movement of pointing device 500 and the corresponding positional information for robot 514, other embodiments in accordance with the invention are not limited to this implementation. By way of example only, processing circuit 508 receives the output signals from magnetic sensors 502, 504, 506 and determines the movement of pointing device 500 and controller 516 determines the corresponding positional information for robot 514 in another embodiment in accordance with the invention.

FIG. 6 illustrates two mounting plates each with a magnetic sensor mounted thereon in an embodiment in accordance with the invention. Magnetic sensors 600, 602 are each mounted on mounting plates 604, 606, respectively. Mounting plates 604, 606 are positioned in two orthogonal directions within a pointing device (not shown). This mounting scheme positions sensors 600, 602 orthogonal to each other and allow each sensor 602, 604 to measure a magnetic field component in a respective orthogonal direction. The measured magnetic field components are then analyzed to determine the direction and speed a pointing device is moved by a user.

Referring now to FIG. 7, there is shown a mounting cube with three magnetic sensors mounted thereon in an embodiment in accordance with the invention. Mounting cube 700 includes three magnetic sensors 702, 704, 706. Each sensor 702, 704, 706 is mounted to a different side of cube 700. This mounting scheme positions sensors 702, 704, 706 orthogonal to each other and allows each sensor 702, 704, 706 to measure a magnetic field component in a respective orthogonal direction. The measured magnetic field components are then analyzed to determine the direction, speed, and angular rotation of a pointing device.

Embodiments in accordance with the invention are not limited to the mounting scheme shown in FIG. 7. Other embodiments in accordance with the invention can mount magnetic sensors 702, 704, 706 differently. For example, three individual mounting plates can each have a magnetic sensor mounted thereon. Each mounting plate is then positioned in a respective orthogonal direction.

The magnetic fields measured by pointing device 400 and pointing device 500 are derived generally from the earth's geo-magnetic fields in an embodiment in accordance with the invention. This allows the pointing device to operate on any surface, including clean, clear glass. The tracking information can also be obtained with a pointing device that moves through free space, such as a game controller or remote controller that provides positional information to any type of an object.

1. A user-controlled pointing device for controlling a movement of an object observed by a user in a visual scene, the user-controlled pointing device comprising:
one or more magnetic sensors each operable to measure a magnetic field component associated with a respective orthogonal direction; and
a processing circuit operable to receive an output signal from each magnetic sensor that represents a respective measured magnetic field component and determine positional information for the object based on a movement of the user-controlled pointing device.

2. The user-controlled pointing device of claim 1, wherein the one or more sensors comprise two or more sensors each positioned orthogonal to each other.

3. The user-controlled pointing device of claim 1, further comprising a communications device operable to transmit the positional information over a communications link.

4. The user-controlled pointing device of claim 1, wherein the visual scene comprises an image displayed on a display device and the object comprises an object included in the image.

5. The user-controlled pointing device of claim 1, wherein the visual scene comprises a view of the object and the object comprises an electronic device operable to be controlled remotely by the user-controlled pointing device.

6. A navigational system for controlling the movement of an object observed in a visual scene by a user, the navigational system comprising:
a user-controlled pointing device comprising one or more magnetic sensors each operable to measure a magnetic field component associated with a respective orthogonal direction and generate an output signal representative of the measured magnetic field component;
a processing circuit operable to receive the output signal from each magnetic sensor and determine positional information for the object based on a movement of the pointing device, wherein the positional information produces a change in a position of the object that corresponds to the movement of the pointing device; and
a communications link established between a controller associated with the object and the pointing device, wherein the communications link is operable to transmit the positional information from the pointing device to the controller associated with the object.

7. The navigational system of claim 6, wherein the user-controlled pointing device comprises two or more magnetic sensors each positioned orthogonal to each other.

8. The navigation system of claim 6, wherein the visual scene comprises an image displayed on a display device and the object comprises an object included in the image.

9. The navigation system of claim 6, wherein the visual scene comprises a view of the object and the object comprises an electronic device operable to be controlled remotely by the user-controlled pointing device.

10. The navigational system of claim 6, wherein the communications link comprises a wired communications link.

11. The navigational system of claim 6, wherein the communications link comprises a wireless communications link.

12. A method for controlling an object observed within a visual scene using a user-controlled pointing device operable to measure magnetic fields, the method comprising:
a) measuring one or more magnetic field components that are each associated with a respective orthogonal direction;
b) determining a movement of the user-controlled pointing device using the one or more measured magnetic field components; and
c) determining positional information for the object in the visual scene based on the movement of the user-controlled pointing device, wherein the positional information produces a change in a position of the object in the visual scene that corresponds to the movement of the user-controlled pointing device.

13. The method of claim 12, further comprising d) transmitting the positional information over a communications link established between the user-controlled pointing device and a controller associated with the object.

14. The method of claim 13, further comprising repeating a) through d) each time the user-controlled pointing device moves.

15. The method of claim 12, further comprising establishing a communications link between the user-controlled pointing device and a controller associated with the object.

16. The method of claim 15, wherein establishing a communications link between the user-controlled pointing device and the display device comprises establishing a wireless communications link between the user-controlled pointing device and the controller.

17. The method of claim 15, wherein establishing a communications link between the user-controlled pointing device and the display device comprises establishing a wired communications link between the user-controlled pointing device and the controller.

18. The method of claim 12, further comprising calibrating the user-controlled pointing device for a particular location where the user-controlled point device is placed when operational.

19. The method of claim 12, further comprising:
receiving a respective gain value for each of the measured magnetic field components; and
applying the gain values to the measured magnetic field components.
